(19) United States
(12) Patent Application Publication
(10) Pub. No.: US 2010/0106668 A1
(43) Pub. Date: Apr. 29, 2010

(54) SYSTEM AND METHOD FOR PROVIDING COMMUNITY WISDOM BASED ON USER PROFILE

(76) Inventors: Louis Hawthorne, Mill Valley, CA (US); Michael Renn Neal, Arvada, CO (US); d'Armond Lee Speers, Thornton, CO (US); Taryn Voget, San Francisco, CA (US); Anne Cushman, Fairfax, CA (US)

Correspondence Address: Goodwin Procter LLP;Attn: Patent Administrator, 135 Commonwealth Drive, Menlo Park, CA, 94025-1105, US

(21) Appl. No.: 12/253,896

(22) Filed: Oct. 17, 2008

(51) Int. Cl. G06F 17/21; G06N 5/04; G06F 17/30

(52) U.S. Cl. 706/11; 706/52; 707/E17.015

(57) ABSTRACT

A new approach is proposed that contemplates systems and methods to provide one or more potential solutions to a user solicited from a community of wisdom, wherein such solutions are not only relevant to addressing a problem raised by the user, but are also customized to the specific needs and preferences of the user based on the user's profile. Such an approach enables a personalized “agent” who understands the user's specific needs and interests by maintaining a personal profile of the user. Based on such in-depth personal knowledge and understanding, the agent is capable of soliciting, customizing, and presenting the solutions from an online community to the user that specifically address his/her problem or concern.

### RELATED APPLICATIONS

This application is related to U.S. patent application Ser. No. ______ being concurrently filed; and entitled “A system and method for content customization based on user profile,” by Louis Hawthorne et al., and is hereby incorporated herein by reference.

### BACKGROUND

With the growing popularity of the Internet, people are increasingly seeking answers to their problems and concerns online. Due to the overwhelming amount of information that is available over the Internet, however, it is often difficult for a lay person to browse over the Web to find the solution or advice that actually addresses his/her problem. Even when the user is able to find a solution or advice that is relevant to his/her problem, such advice is most likely to be of “one size fits all” type that addresses the concerns of the general public while it does not target the specific needs of the user as an individual. To make matters worse, the user may quite often find varying advice to his/her problem from various self-claimed experts that are different or even conflict with each other and the user may not know whom to believe or which advice to follow. For a non-limiting example, when a person tries to seek advice on how to handle one of his/her emotional/mental problems, people from different backgrounds, cultures, and experiences may offer different suggestions as to whether anti-depression drugs should be used or not.

The foregoing examples of the related art and limitations related therewith are intended to be illustrative and not exclusive. Other limitations of the related art will become apparent upon a reading of the specification and a study of the drawings.

### BRIEF DESCRIPTION OF THE DRAWINGS

FIG. 1 depicts an example of a system diagram to support providing community wisdom based on user profile.

FIG. 2 illustrates an example of the various pieces of information that may be included in a user profile.

FIG. 3 depicts a flowchart of an example of a process to establish the user's profile.

FIG. 4 depicts a flowchart of an example of a process to solicit potential solutions from a community of responders.

FIG. 5 depicts a flowchart of an example of a process to tag and organize content to establish a solution library/book shelf.

FIG. 6 depicts a flowchart of an example of a process to support providing community wisdom based on user profile.

### DETAILED DESCRIPTION OF EMBODIMENTS

The approach is illustrated by way of example and not by way of limitation in the figures of the accompanying drawings in which like references indicate similar elements. It should be noted that references to “an” or “one” or “some” embodiment(s) in this disclosure are not necessarily to the same embodiment, and such references mean at least one.

A new approach is proposed that contemplates systems and methods to provide one or more potential solutions to a user solicited from a community of wisdom, wherein such solutions are not only relevant to addressing a problem raised by the user, but are also customized to the specific needs and preferences of the user based on the user's profile. Such an approach enables a personalized “agent” who understands the user's specific needs and interests by maintaining a personal profile of the user. The profile is more than a simple tracking of the user's activities online by further including feedback and comments provided by the user him/herself to prior engagements and/or “interview” questions by the agent. Based on such in-depth personal knowledge and understanding, the agent is capable of soliciting, customizing, and presenting the solutions from an online community to the user that specifically address his/her problem or concern. With such an approach, a user can efficiently and accurately find what he/she is looking for and have potential solutions unique to his/her problem that are distinguished from the solutions provided to other users having similar problems.

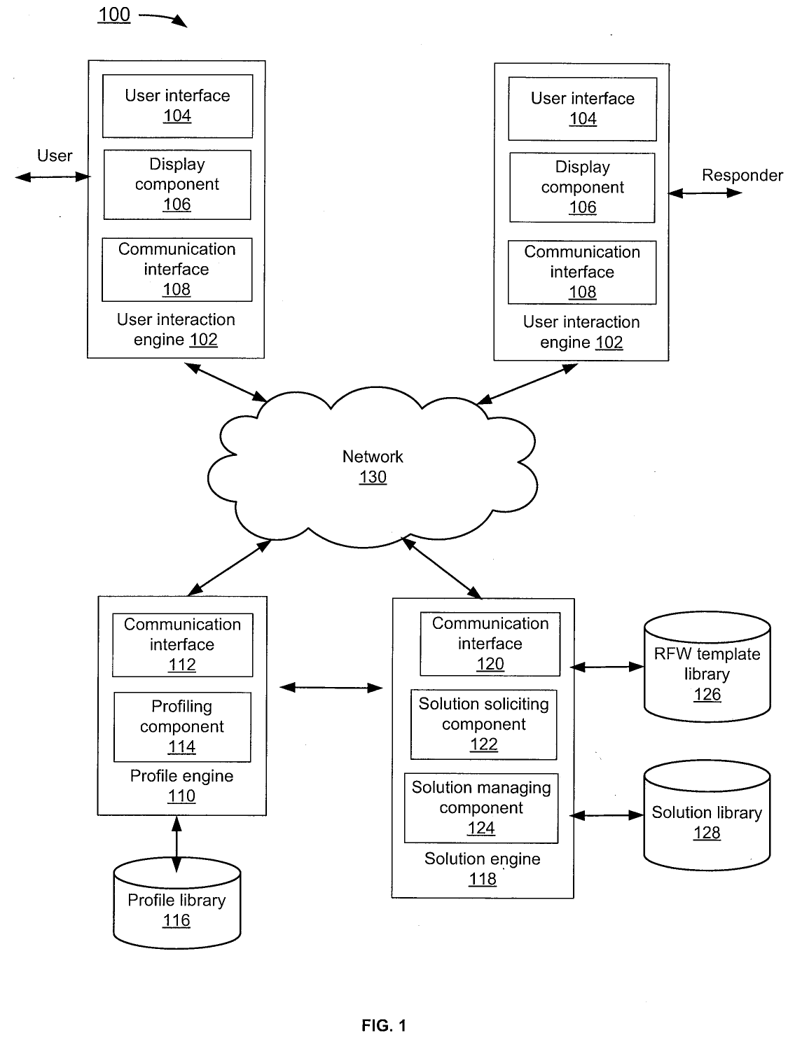

FIG. 1 depicts an example of a system diagram to support providing community wisdom based on user profile. Although the diagrams depict components as functionally separate, such depiction is merely for illustrative purposes. It will be apparent that the components portrayed in this figure can be arbitrarily combined or divided into separate software, firmware and/or hardware components. Furthermore, it will also be apparent that such components, regardless of how they are combined or divided, can execute on the same host or multiple hosts, and wherein the multiple hosts can be connected by one or more networks.

In the example of FIG. 1, the system 100 includes one or more user interaction engines 102, which each includes at least a user interface 104, a display component 106, and a communication interface 108; a profile engine 110, which includes at least a communication interface 112 and a profiling component 114; a profile library (database) 116 coupled to the profile engine 110; a solution engine 118, which includes at least a communication interface 120, a solution soliciting component 122, and a solution managing component 124; a request for wisdom (RFW) template library (database) 126 and a solution library (database) 128, both coupled to the solution engine 118; and a network 130.

As used herein, the term engine refers to software, firmware, hardware, or other component that is used to effectuate a purpose. The engine will typically include software instructions that are stored in non-volatile memory (also referred to as secondary memory). When the software instructions are executed, at least a subset of the software instructions is loaded into memory (also referred to as primary memory) by a processor. The processor then executes the software instructions in memory. The processor may be a shared processor, a dedicated processor, or a combination of shared or dedicated processors. A typical program will include calls to hardware components (such as I/O devices), which typically requires the execution of drivers. The drivers may or may not be considered part of the engine, but the distinction is not critical.

As used herein, the term library or database is used broadly to include any known or convenient means for storing data, whether centralized or distributed, relational or otherwise.

In the example of FIG. 1, each of the engines and libraries can run on one or more hosting devices (hosts). Here, a host can be a computing device, a communication device, a storage device, or any electronic device capable of running a software component. For non-limiting examples, a computing device can be but is not limited to, a laptop PC, a desktop PC, a tablet PC, an iPod, a PDA, or a server machine. A storage device can be but is not limited to a hard disk drive, a flash memory drive, or any portable storage device. A communication device can be but is not limited to a mobile phone.

In the example of FIG. 1, the user interaction engine 102 is configured to enable a user to submit a problem to which the user intends to seek advice, help or counseling via the user interface 104 and to view one or more potential solutions provided by a community of users relevant to addressing the problem submitted by the user via the display component 106. Here, the problem (or question, interest, issue, event, condition, or concern, hereinafter referred to a problem) of the user provides the context for the potential solutions that are to be presented to him/her. The problem can be related to one or more of personal, emotional, spiritual, relational, physical, medical, practical, or any other need of the user. In some embodiments, the user interface 104 can be a Web-based browser, which allows the user to access the system 100 remotely via the network 130.

In some embodiments, the user interaction engine 102 presents a pre-determined list of problems that could possibly be raised by the user in the form of a list, such as a pull down menu, and the user may submit his/her problem by simply picking and choosing a problem in the menu. Such menus can be organized by various categories or topics in more than one level. By organizing and standardizing the potential problems from the user, the menu not only saves the user's time and effort in submitting the problems, but also makes it easier to identify relevant RFW templates and/or solutions to the problem submitted.

In some embodiments, the user interaction engine 102 informs the user whether there is enough relevant material in the solution library 128 to generate one or more potential solutions to the problem submitted by the user or not. If there is not enough relevant material in the solution library 128, a request for (community) wisdom (RFW) can be initiated by the user or by the solution engine 118 transparent to the user to solicit the potential solutions from a community. Here, the community of wisdom includes one or more responders who can be but are not limited to,

other registered users in the community who are eligible to respond to RFWs to provide original content such as personal stories or essays perhaps because their contributions in the past have received good feedback and ratings.

professionals, experts, and service providers who are deemed to be qualified to provide a credible solution to the user who submitted the problem. For a non-limiting example, psychiatrists who are leading authorities in their spiritual domains or in self-help or psychological professions.

In some embodiments, the user interaction engine 102 is configured to enable the user to determine how he/she prefers an RFW to be sent to the community of wisdom from a plurality of options that include but are not limited to the following:

RFW to experts, professionals, and service providers only.

RFW to users in the community who registered to receive RFWs and have similar profiles and/or experiences as the user.

RFW to users in the entire community who have registered to receive RFWs.

In some embodiments, the user interaction engine 102 is configured to enable the user to provide feedback to the potential solutions provided to him/her via the user interface 104. Here, such feedback can be, for non-limiting examples, ratings or ranking of the content, indication of preference as whether the user would like to see the same or similar solutions in the same category in the future, or any written comments or suggestions on the solutions that eventually drive the customization of the solutions. For non-limiting examples, a rating can be from 0-10 where 0 is worst and 10 is best, or 5 stars. There can also be a comment by a user that he/she trusts the responder or not.

In some embodiments, the user interaction engine 102 is configured to enable a responder (e.g., an expert, a professional, a service provider, or another registered user) in the community who is willing to accept the RFW and is qualified to provide a potential solution to the problem to accept and review the RFW for the problem submitted via the display component 106. The user interaction engine 102 is also configured to enable the responder to generate and submit a potential solution such as a statement of wisdom (SOW) to the problem to the solution engine 118 via the user interface 104. The responder can either choose to be anonymous (hide alias/screen name) from the recipient of the SOW (e.g., the user who submits the problem) or can alternatively leave his/her alias/screen name visible.

In the example of FIG. 1, the profile engine 110 manages a profile of the user maintained in the profile library 116 via the profiling component 114 for the purpose of generating and customizing the potential solutions to be presented to the user. The user profile may contain at least the following areas of user information:

Administrative information includes account information such as name, region, email address, and payment options of the user.

Static profile contains information about the user that does not change over time, such as the user's gender and date of birth to calculate his/her age and for potential astrological consideration.

Dynamic profile contains information about the user that may change over time, such as parental status, marital status, relationship status, as well as current interests, hobbies, habits, and concerns of the user.

Psycho-Spiritual Dimension describes the psychological, spiritual, and religious component of the user, such as the user's belief system (a religious, philosophical or intellectual tradition, e.g., Christian, Buddhist, Jewish, atheist, non-religious), degree of adherence (e.g., committed/devout, practicing, casual, no longer practicing, “openness” to alternatives) and influences (e.g., none, many, parents, mother, father, other relative, friend, spouse, spiritual leader/religious leader, self).

Community Profile contains information defining how the user interacts with the online community of experts, professionals, and other registered users (e.g., whom he/she prefers or blocks in the community) and to which problems the user is willing to receive RFWs and to provide his/her own response on the matter.

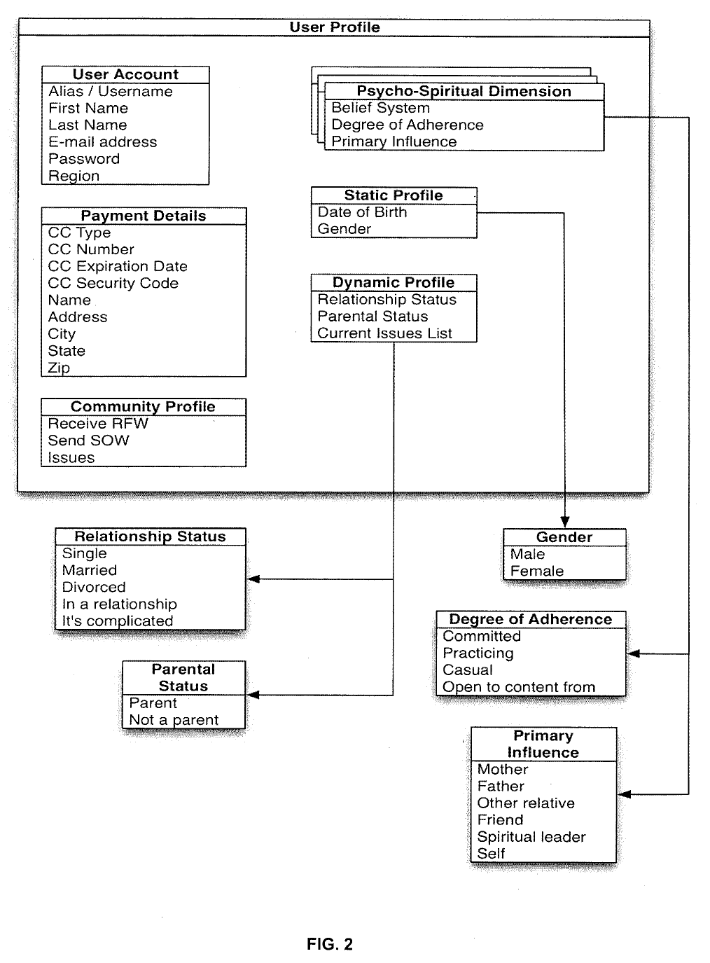

FIG. 2 illustrates an example of the various pieces of information that may be included in a user profile.

In some embodiments, the profile engine 110 initiates one or more questions to the user via the user interaction engine 102 for the purpose of soliciting and gathering at least part of the information listed above to establish the profile of the user. Here, such questions focus on the aspects of the user's life that are not available through other means. The questions initiated by the profile engine 110 may focus on the personal interests, spiritual dimensions as well as dynamic and community profiles of the user. For a non-limiting example, the questions may focus on the user's personal interests, which may not be truly obtained by simply observing the user's online habits.

In some embodiments, the profile engine updates the profile of the user via the profiling component 114 based on the prior history/record and dates of one or more of:

problems that have been raised by the user;

relevant solutions that have been presented to the user;

RFW templates that have been used to generate and present the solutions to the user;

feedback from the user to the solutions that have been presented to the user;

RFWs and feedback if any that the user has received and responded to problems submitted by others.

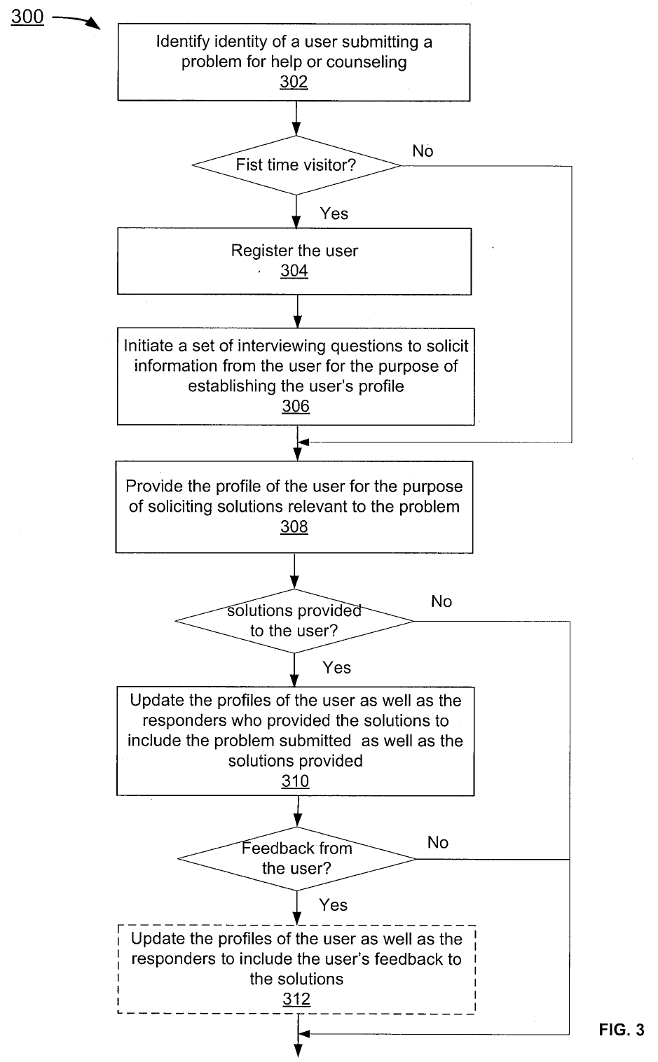

FIG. 3 depicts a flowchart of an example of a process to establish the user's profile. Although this figure depicts functional steps in a particular order for purposes of illustration, the process is not limited to any particular order or arrangement of steps. One skilled in the relevant art will appreciate that the various steps portrayed in this figure could be omitted, rearranged, combined and/or adapted in various ways.

In the example of FIG. 3, the flowchart 300 starts at block 302 where the identity of the user submitting a problem for help or counseling is identified. If the user is a first time visitor, the flowchart 300 continues to block 304 where the user is registered, and the flowchart 300 continues to block 306 where a set of interviewing questions are initiated to solicit information from the user for the purpose of establishing the user's profile. The flowchart 300 continues to block 308 where the profile of the user is provided to the solution engine 118 for the purpose of soliciting solutions relevant to the problem. Once the solutions have been generated and provided to the user, the flowchart 300 continues to block 310 where the profiles of the user as well as the responders who provided the solutions are updated to include the problem submitted by the user as well as the solutions provided. If the user optionally provides feedback to the solutions, the flowchart 300 ends at block 312 where the profiles of the user as well as the responders are updated to include the user's feedback to the solutions provided.

In the example of FIG. 1, the solution engine 118 solicits one or more potential solutions to the problem submitted by the user from a number of responders in the community by sending them RFWs via the solution soliciting component 122 and manages and provides the solicited solutions to the user that best address his/her problem via solution managing component 124. A solution or statement of wisdom (SOW) in response to a RFW, which also refers to advice or answer herein, is not a “post” to a discussion board. Rather, the solution may include one or more items, each of which can be individually solicited, customized, composed, and presented by the solution engine 118 to the user online as part of a potential solution to the user's submitted problem. Here, each item in a solution can be of the media type of text, an image, a video clip, an audio clip, and other types of items from which a solution can be provided by the responder to the user. Each item in the solution can either be generated by the responder him/herself or readily available from a third party (e.g., a book passage or a video clip).

In some embodiments, each of a text, image, video, and audio item can include one or more elements of: title, author (name, unknown, or anonymous), body (the actual item), source, type, and location. For a non-limiting example, a text item can include a source element of one of professional advice, personal experience, psychology, self help, and religious, and a type element of one of essay, book passage, formal advice, personal story, reference, poem, quote, sermon, speech, and summary. For another non-limiting example, a video, an audio, and an image item can all include a location element that points to the location (e.g., file path or URL) or access method of the video, audio, or image item. In addition, an audio item may also include elements on album, genre, or track number of the audio item as well as its audio type (music or spoken word).

In some embodiments, the solution engine 118 can associate each of the text, image, video, and audio items in a solution with a link to a resource or provider of the item from where the user can further pursue the solutions provided. Such resource can be but is not limited to one or more of: contact information of a professional such as a doctor, a lawyer, or a provider of a recommended service, link to further details of the item, or a link to purchase the item, if it is purchasable, from an affiliated vendor of the item, such as Amazon Associates, itunes, etc. The user interaction engine 102 can then present the link together with the corresponding item in the solution to the user and enable the user to pursue an item of his/her interest.

In some embodiments, the solution engine 118 determines and selects one or more responders in the community to solicit the one or more solutions from (e.g., by sending them the RFW). Such determination is based on at least one or more of the following factors:

The preference as specified by the user (e.g., RFW to experts and professionals only).

The prior community experience of the user who submitted the problem, e.g., whom are his/her preferred responders in the community that the user considers as having provided valuable/helpful advice and solutions in the past.

Credentials of experts and professionals who are experienced in the area to answer the submitted problem.

Users with similar profiles or experiences as the user who submitted the problem.

Feedback and ratings to prior responses from the potential responder candidates.

Current workload of the responders in the community, e.g., the number of RFWs each responder has received and responded to/not responded to.

In some embodiments, when the user is having difficulty making an informed decision as to whom the RFW should be sent, the solution engine 118 may provide the user with a set of potential candidates whom the user may likely prefer to seek advice from. These candidates are selected by the solution engine 118 based on their prior experiences with the problem submitted such as experts or professionals in the area or users in the community who have had similar experiences. For each of the candidates recommended, the solution engine 118 may further provide a brief description of their qualifications as well as their profiles for the user to make an informed decision. The user may then be enabled to selectively send the RFW to all or only a subset of the candidates recommended.

In some embodiments, the solution engine 118 can set a limit on the total number of RFWs (each to one or more responders) to be sent out for each single problem submitted by the user (in order not to flood and overload the community with RFWs and SOWs). The solution engine 118 can also set a time limit for each of the selected one or more responders to respond, based on the urgency and criticality of the user's problem. For a non-limiting example, if a selected responder has not answered after a week, the responder is considered as non-responsive to the submitted problem.

In some embodiments, the solution engine 118 may generate the RFW associated with the problem raised by the user by identifying an RFW template for the problem from the RFW template library 126, customizing the RFW template based on the profile of the user before sending it to the one or more responders. Here, an RFW template defines a format and/or types of solution items to be provided by the responders in order to compose a potential solution. Some of the items can be marked as required while others can be marked as optional.

In some embodiments, the solution engine 118 may evaluate, customize, moderate, and approve the potential solutions solicited from the responders. Since each responder may have provided a potential solution from his/her own perspective, the potential solutions gathered from the responders can be inconsistent with each other. In some embodiments, the solution engine 118 may analyze and characterize the potential solutions into various categories, weigh and assign different numerical metrics to each of the potential answers based upon, for a non-limiting example, the credibility and experience levels of the responders, in order to come up with one or more appropriate solutions that will most likely address the problem of the user. During the evaluation process, the solution engine 118 may utilize domain expertise in the respective areas to evaluate the solutions solicited and continuously monitor and adjust/tune the solutions based on the user's feedback.

In some embodiments, the solution engine 118 may customize or moderate the solutions solicited based on the user's profile including one or more of: the user's dynamic profile (e.g., current relationship status), his/her spiritual dimension (e.g., belief system), his/her recent comments and ratings on solutions related to the same or relevant problems, and his/her responses to requests for wisdom. For a non-limiting example, solutions that do not appeal to the user in the past based on his/her feedback will likely be excluded. In some situations when the user is not sure what he/she is looking for, the user may simply choose “Cheer me up” from the problem list and the solution engine 118 will automatically retrieve and present potential ways to cheer the user up based on the user's profile.

In some embodiments, the solution engine 118 may customize the one or more solutions based on an “experience path” of the user. Here, the user experience path reflects the user's experience with or knowledge of the problem he/she submitted. The user experience path contains a list of path nodes, each of which represents a stage in the user's experience/knowledge progression process, for a non-limiting example, stages of expertise from: novice→amateur→professional→expert→guru. By associating the user experience path and path nodes with the potential solutions, the solution engine 118 can select the appropriate solutions for the user that are appropriate to his/her current state of experience or knowledge. In the example above, the solutions for a user new to the problem will be considerably different from a user who already had in-depth knowledge of the problem.

In some embodiments, the solution engine 118 determines if the potential solutions to the problem should be saved in the solution library 128 as community wisdom or not along with the problem, the user's profile, and other relevant factors used to customize the potential solutions. In some embodiments, the solution engine 118 examines the content of the solutions to see how they would enhance the current community wisdom if included in the solution library 128. The solution engine 118 may also review the ratings and feedback from the user on the solutions provided to determine whether the solutions should be included in the solution library 128 or not. Alternatively, the solution engine 118 may make the solutions available not only to the user who submitted the problem, but also to a set of other users whose profiles match that of the user who submitted the problem, plus experts and/or professionals in the community as well to give them a chance to review, rate, and vote on the solutions as to whether the solutions should be included in the solution library 128 or not.

In the example of FIG. 1, the profile library 116 embedded in a computer readable medium, which in operation, maintains a set of user profiles of the registered users in the community. The RFW template library 126 maintains RFW templates corresponding to the pre-defined of problems that are available to the user, while the solution library 128 maintains solutions (and their included items) as well as definitions, tags, and resources of the solutions relevant to the user-submitted problems. The solution library 128 covers both the definition of the solutions and how the solution tags are applied. It may serve as a “book shelf” that includes a collection of solutions relevant and customized based on each user's profile, experiences, and preferences, including a collection of RFWs and corresponding SOWs to the problems submitted by the users. The solution engine 118 may retrieve solutions and their items from the solution library 128 so that they will be readily available when a similar problem is raised again by a user with similar profile.

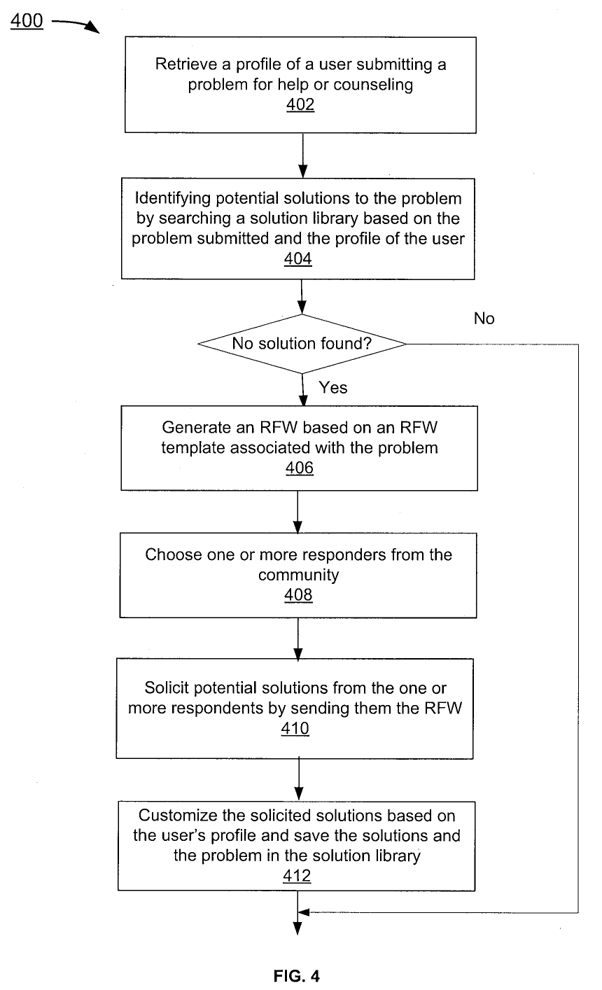

FIG. 4 depicts a flowchart of an example of a process to solicit potential solutions from a community of responders. Although this figure depicts functional steps in a particular order for purposes of illustration, the process is not limited to any particular order or arrangement of steps. One skilled in the relevant art will appreciate that the various steps portrayed in this figure could be omitted, rearranged, combined and/or adapted in various ways.

In the example of FIG. 4, the flowchart 400 starts at block 402 where the profile of a user submitting a problem for help or counseling is retrieved. The flowchart 400 continues to block 404 where the solution library 128 is searched based on the problem submitted and the profile of the user for the purpose of identifying potential solutions to the problem. If no adequate solution is found in the solution library, the flowchart 400 continues to block 406 where an RFW is generated based on an RFW template associated with the problem. The flowchart 400 continues to block 408 where one or more responders are chosen from the community by the solution engine 118. The flowchart 400 continues to block 410 where potential solutions are solicited from one or more responders by sending them the RFW. The flowchart 400 ends at block 412 where the potential solutions (SOWs) solicited are customized based on the user's profile and saved in the solution library 128.

In some embodiments, the solutions in the solution library 128 can be tagged and organized appropriately to enable the solution engine 118 to access and browse the solution library 128 for the purpose of easy identification, retrieval, and customization. Here, the solution engine 118 may browse the solutions by problems, types of solution items, dates collected, and by certain categories such as belief systems to build the solution based on the user's profile and/or understanding of the items' “connections” with the problem submitted by the user. For a non-limiting example, a sample music clip might be selected to be included in the solution because it was encoded to “cheer up” a user.

In some embodiments, each solution and/or item in the solution library 128 can be associated with multiple tags for the purpose of easy identification, retrieval, and customization by the solution engine 118 based on the user's profile. For a non-limiting example, a pair of (belief system, degree of adherence range) can be used to tag a solution as either appropriate for all Christians (Christian, 0-10) or only for devout Christians (Christian, 8-10). Thus, the solution engine 118 will only retrieve an item as part of a solution for the user where the tag of the item matches the user's profile.

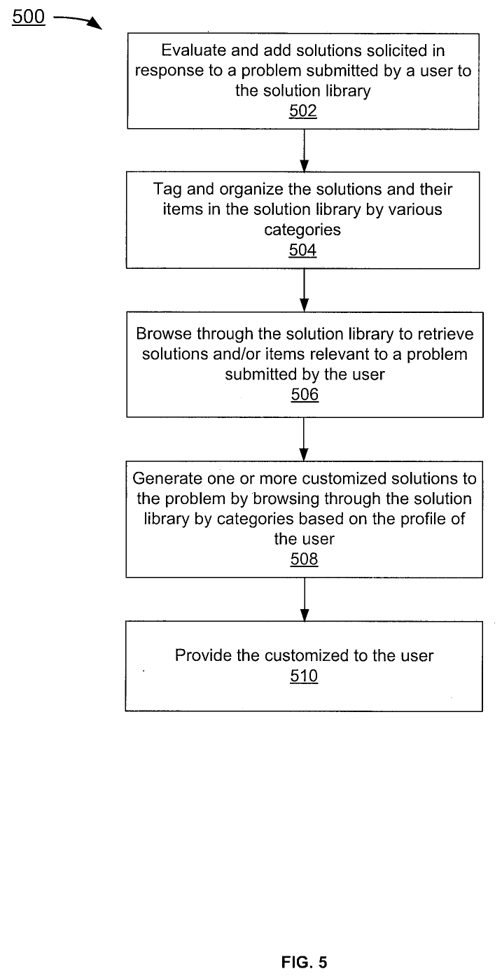

FIG. 5 depicts a flowchart of an example of a process to tag and organize content to establish a solution library/book shelf. Although this figure depicts functional steps in a particular order for purposes of illustration, the process is not limited to any particular order or arrangement of steps. One skilled in the relevant art will appreciate that the various steps portrayed in this figure could be omitted, rearranged, combined and/or adapted in various ways.

In the example of FIG. 5, the flowchart 500 starts at block 502 where solutions solicited in response to a problem submitted by a user are evaluated and added to the solution library 128. The flowchart 500 continues to block 504 where solutions and/or their items in the solution library 128 are tagged and organized by various categories. The flowchart 500 continues to block 506 where the solution engine 118 is able to browse through the solution library 128 to retrieve solutions and/or items relevant to a problem submitted by the user. The flowchart 500 continues to block 508 where the solution engine 118 is further able to generate one or more customized solutions to the problem by browsing through the solution library 128 by categories based on the profile of the user. The flowchart 500 continues to block 510 where the customized solution is provided to the user.

In the example of FIG. 1, the communication interface 108, 112, and 120 are software components that enables the user interaction engine 102, the profile engine 110, and the solution engine 118 to communicate with each other following certain communication protocols, such as TCP/IP protocol. The communication protocols between two devices are well known to those of skill in the art.

In the example of FIG. 1, the network 130 enables the user interaction engine 102, the profile engine 110, and the solution engine 118 to communicate and interact with each other. Here, the network 130 can be a communication network based on certain communication protocols, such as TCP/IP protocol. Such a network can be, but is not limited to, Internet, intranet, wide area network (WAN), local area network (LAN), wireless network, Bluetooth, WiFi, and mobile communication network. The physical connections of the network and the communication protocols are well known to those of skill in the art.

While the system 100 depicted in FIG. 1 is in operation, the user interaction engine 102 enables the user to register, login, and submit a problem of his/her concern via the user interface 104. The user interaction engine 102 communicates the identity of the user together with the problem raised by the user to the solution engine 118 and/or the profile engine 110. If the user is visiting for the first time, the profile engine 110 may interview the user with a set of questions in order to establish a profile of the user that accurately reflects the user's interests or concerns. Upon receiving the problem and the identity of the user, the solution engine 118 obtains the profile of the user from the profile library 116 and searches the solution library 128 for one or more potential solutions to the problem submitted. If no solution is readily available in the solution library 128, the solution engine 118 retrieves an RFW template for the problem from the RFW template library 126, generates an RFW from the RFW template, selects a group of responders that includes experts, professionals, and/or other users with similar profiles or experiences, and solicits potential solutions from the responders by sending them the RFW via the solution soliciting component 122. Once the responders reply, the solution engine 118 reviews, customizes, and saves the solicited solutions as part of community wisdom based on the user's profile in order to generate solutions that best address the user's problem via the solution managing component 124, before providing the customized solutions for the user to review. The user interaction engine 102 receives the potential solutions from the solution engine 118 and enables the user to review them via the display component 106 and to rate or provide feedback to the solutions presented. The profile engine 110 may then update the user's profile as well as profiles of the responders who provided the solutions with the problems raised by the user, the solutions to the user, and the feedback and ratings from the user.

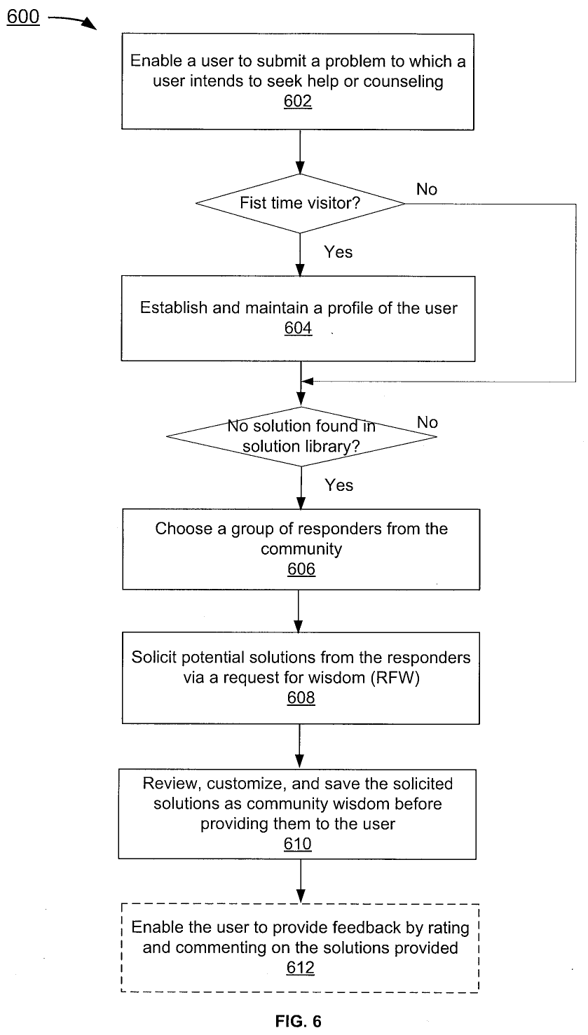

FIG. 6 depicts a flowchart of an example of a process to support providing community wisdom based on a user profile. Although this figure depicts functional steps in a particular order for purposes of illustration, the process is not limited to any particular order or arrangement of steps. One skilled in the relevant art will appreciate that the various steps portrayed in this figure could be omitted, rearranged, combined and/or adapted in various ways.

In the example of FIG. 6, the flowchart 600 starts at block 602 where a user is enabled to submit a problem to which the user intends to seek help or counseling. The problem submission process can be done via a user interface and be standardized via a list of pre-defined problems organized by topics and categories.

In the example of FIG. 6, the flowchart 600 continues block 604 where a profile of the user is established and maintained if the user is visiting for the first time or the user's current profile is otherwise thin. At least a portion of the profile can be established by initiating interview questions to the user targeted at soliciting information on his/her personal interests and/or concerns. In addition, the profile of the user can be continuously updated with the problems raised by the user and the solutions provided to him/her.

In the example of FIG. 6, the flowchart 600 continues block 606 where a group of responders are chosen from the community if a solution is not readily available in a solution library. Here, the group of responders can be chosen based on the various criteria including the credentials and prior experiences of the responders and the user.

In the example of FIG. 6, the flowchart 600 continues block 608 where the potential solutions to the problem are solicited from the responders via a request for wisdom (RFW). Here, the RFW can be generated based on an RFW template associated with the problem submitted by the user and customized based on the user's profile.

In the example of FIG. 6, the flowchart 600 continues to block 610 where the solicited solutions are reviewed, customized, and saved as community wisdom before being provided to the user. Such customization can be based on the user's profile, personal interest, spiritual dimensions, past experiences, and feedback history.

In the example of FIG. 6, the flowchart 600 may optionally continue to block 612 where the user is enabled to provide feedback by rating and commenting on the solutions provided. Such feedback will then be used to update the profiles of the user as well as of the responders who provide them in order to make solutions provided from the community wisdom in the future more accurate.

One embodiment may be implemented using a conventional general purpose or a specialized digital computer or microprocessor(s) programmed according to the teachings of the present disclosure, as will be apparent to those skilled in the computer art. Appropriate software coding can readily be prepared by skilled programmers based on the teachings of the present disclosure, as will be apparent to those skilled in the software art. The invention may also be implemented by the preparation of integrated circuits or by interconnecting an appropriate network of conventional component circuits, as will be readily apparent to those skilled in the art.

One embodiment includes a computer program product which is a machine readable medium (media) having instructions stored thereon/in which can be used to program one or more hosts to perform any of the features presented herein. The machine readable medium can include, but is not limited to, one or more types of disks including floppy disks, optical discs, DVD, CD-ROMs, micro drive, and magneto-optical disks, ROMs, RAMs, EPROMs, EEPROMs, DRAMs, VRAMs, flash memory devices, magnetic or optical cards, nanosystems (including molecular memory ICs), or any type of media or device suitable for storing instructions and/or data. Stored on any one of the computer readable medium (media), the present invention includes software for controlling both the hardware of the general purpose/specialized computer or microprocessor, and for enabling the computer or microprocessor to interact with a human viewer or other mechanism utilizing the results of the present invention. Such software may include, but is not limited to, device drivers, operating systems, execution environments/containers, and applications.

The foregoing description of various embodiments of the claimed subject matter has been provided for the purposes of illustration and description. It is not intended to be exhaustive or to limit the claimed subject matter to the precise forms disclosed. Many modifications and variations will be apparent to the practitioner skilled in the art. Particularly, while the concept “interface” is used in the embodiments of the systems and methods described above, it will be evident that such concepts can be interchangeably used with equivalent software concepts such as class, method, type, module, component, bean, module, object model, process, thread, and other suitable concepts. While the concept “component” is used in the embodiments of the systems and methods described above, it will be evident that such a concept can be interchangeably used with equivalent concepts such as, class, method, type, interface, module, object model, and other suitable concepts. Embodiments were chosen and described in order to best describe the principles of the invention and its practical application, thereby enabling others skilled in the relevant art to understand the claimed subject matter, the various embodiments and with various modifications that are suited to the particular use contemplated.

What is claimed is:

1. A system, comprising:
a profile engine, which in operation, establishes and maintains a profile of a user;
a user interaction engine, which in operation,
enables the user to submit a problem to which the user intends to seek advice, help or counseling;
provides to the user one or more potential solutions to the problem submitted by the user;
a solution engine, which in operation,
selects a group of responders in a community of wisdom;
solicits the one or more solutions relevant to the problem from the group of responders;
reviews and customizes the one or more solutions based on the profile of the user.

2. The system of claim 1, wherein:
the problem submitted by the user relates to one or more of: personal, emotional, spiritual, psychological, relational, physical, medical, practical, or any other need of the user.

3. The system of claim 1, wherein:
the group of responders includes one or more of: experts, professionals, service providers, and other users in the community.

4. The system of claim 1, further comprising:
a profile library embedded in a computer readable medium, which in operation, maintains the user profile of the user.

5. The system of claim 1, wherein:
the profile of the user includes one or more of: name, address, date of birth, gender, parental status, marital status, relationship status, belief system, psycho-spiritual dimensions, personal interests, hobbies, habits of the user.

6. The system of claim 1, wherein:
the profile of the user includes history of one or more of:
problems that have been raised by the user;
relevant solutions that have been presented to the user;
request for wisdom (RFW) templates that have been used to generate and present the one or more solutions to the user;
feedback from the user to the solutions that have been presented to the user;
RFWs and feedback if any that the user has received and responded to problems submitted by others.

7. The system of claim 1, wherein:
the user interaction engine is configured to enable the user to initiate a RFW to solicit the potential solutions from the community.

8. The system of claim 7, wherein:
the user interaction engine is configured to enable the user to determine how he/she prefers the RFW to be sent to the community.

9. The system of claim 7, wherein:
the solution engine solicits the one or more potential solutions to the problem submitted by the user by sending the RFW to the group of responders in the community.

10. The system of claim 1, wherein:
the user interaction engine is configured to enable the user to provide feedback to the one or more solutions provided.

11. The system of claim 10, wherein:
the profile engine updates the profiles of the user and the responders of the one or more solutions based on the problem, the solutions, and feedback from the user.

12. The system of claim 1, wherein:
the user interaction engine is configured to enable each of the group of responders to:
accept and review the RFW for the problem submitted;
generate a potential solution to the problem and submit the solution to the solution engine.

13. The system of claim 1, wherein:
the profile engine initiates one or more questions to the user to solicit information for the purpose of establishing the profile of the user.

14. The system of claim 1, wherein:
each of the one or more solutions includes one or more items, wherein each of the one or more items is a text, an image, an audio, or a video item.

15. The system of claim 14, wherein:
at least one item in the one or more solutions is created by a third party.

16. The system of claim 14, wherein:
at least one item in the one or more solutions is created by the group of responders.

17. The system of claim 14, wherein:
the solution engine associates a link to a resource of each item in a solution from where the user can further pursue the solution provided.

18. The system of claim 17, wherein:
the user interaction engine presents the link together with the corresponding item in the solution to the user.

19. The system of claim 1, further comprising:
a solution library embedded in a computer readable medium, which in operation, maintains solutions as well as definitions, tags, and source of the solutions relevant to user-submitted problems.

20. The system of claim 19, wherein:
the solution engine searches the solution library for the one or more potential solutions to the problem before soliciting the solutions from the group of responders.

21. The system of claim 19, wherein:
the solution engine saves the one or more solutions to the problem in the solution library as community wisdom together with the problem, the user's profile, and other relevant factors used to customize the solutions.

22. The system of claim 19, wherein:
the solutions in the solution library are tagged and organized appropriately for the purpose of easy identification, retrieval, and customization.

23. The system of claim 1, wherein:
the solution engine selects the group of responders based on one or more of: the user's preference and prior experiences with the group of responders, credentials and experiences of the responders, and current loads of the group of responders.

24. The system of claim 1, wherein:
the solution engine provides the user with a set of potential candidates whom the user may likely prefer to seek advice from.

25. The system of claim 1, wherein:
the solution engine sets a limit on the total number of RFWs to be sent out for the problem submitted by the user.

26. The system of claim 1, wherein:
the solution engine sets a time limit for each of the group of responders to respond.

27. The system of claim 1, further comprising:
a RFW template library embedded in a computer readable medium, which in operation, maintains a set of RFW templates associated with a set of problems.

28. The system of claim 27, wherein:
the solution engine
identifies a RFW template in the RFW template library associated with the problem submitted by the user;
customizes the RFW template based on the profile of the user before sending it to the group of responders.

29. The system of claim 1, wherein:
the solution engine customizes the one or more solutions based on one or more of: the user's dynamic profile, his/her spiritual dimension, his/her recent comments and ratings on solutions related to the same or relevant problems, and his/her responses to requests for wisdom.

30. The system of claim 1, wherein:
the solution engine customizes the one or more solutions based on an experience path of the user.

31. A computer-implemented method, comprising:
establishing and maintaining a profile of a user;
enabling the user to submit a problem to which the user intends to seek help or counseling;
choosing a group of responders from a community;
soliciting one or more potential solutions from the responders;
reviewing and customizing the one or more solicited solutions based on the profile of the user;
providing the one or more solicited solutions to the user.

32. The method of claim 31, further comprising:
enabling the user to initiate a RFW to solicit the potential solutions from the community.

33. The method of claim 32, further comprising:
enabling the user to determine how he/she prefers the RFW to be sent to the community.

34. The method of claim 32, further comprising:
soliciting the one or more potential solutions to the problem submitted by the user by sending the RFW to the group of responders in the community.

35. The method of claim 31, further comprising:
enabling the user to provide feedback to the one or more solutions provided.

36. The method of claim 35, further comprising:
updating the profiles of the user and the responders of the one or more solutions based on the problem, the solutions, and feedback from the user.

37. The method of claim 31, further comprising:
enable each of the group of responders to:
accept and review the RFW for the problem submitted;
generate a potential solution to the problem and submit the solution to the solution engine.

38. The method of claim 31, further comprising:
initiating one or more questions to the user to solicit information for the purpose of establishing the profile of the user.

39. The method of claim 31, further comprising:
associating a link to a resource of each item in a solution from where the user can further pursue the solution provided;
presenting the link together with the corresponding item in the solution to the user.

40. The method of claim 31, further comprising:
searching a solution library for the one or more potential solutions to the problem before soliciting the solutions from the group of responders.

41. The method of claim 31, further comprising:
saving the one or more solutions to the problem in a solution library as community wisdom together with the problem, the user's profile, and other relevant factors used to customize the solutions.

42. The method of claim 41, further comprising:
tagging and organizing the one or more solutions in a solution library appropriately for the purpose of easy identification, retrieval, and customization.

43. The method of claim 31, further comprising:
selecting the group of responders based on one or more of: the user's preference and prior experiences with the group of responders, credentials and experiences of the responders, and current loads of the group of responders.

44. The method of claim 31, further comprising:
providing the user with a set of potential candidates whom the user may likely prefer to seek advice from.

45. The method of claim 31, further comprising:
setting a limit on the total number of RFWs to be sent out for the problem submitted by the user.

46. The method of claim 31, further comprising:
setting a time limit for each of the group of responders to respond.

47. The method of claim 31, further comprising:
Maintaining, identifying, and retrieving a RFW template associated with the problem;
customizing the RFW template based on the profile of the user before sending it to the group of responders.

48. The method of claim 31, further comprising:
customizing the one or more solutions based on one or more of: the user's dynamic profile, his/her spiritual dimension, his/her recent comments and ratings on solutions related to the same or relevant problems, and his/her responses to requests for wisdom.

49. The method of claim 31, further comprising:
customizing the one or more solutions based on an experience path of the user.

50. A system, comprising:
means for establishing and maintaining a profile of a user;
means for enabling the user to submit a problem to which the user intends to seek help or counseling;
means for choosing a group of responders from a community;
means for soliciting one or more potential solutions from the responders;
means for reviewing and customizing the one or more solicited solutions based on the profile of the user;
means for providing the one or more solicited solutions to the user.

51. A machine readable medium having software instructions stored thereon that when executed cause a system to:
establish and maintain a profile of a user;
enable the user to submit a problem to which the user intends to seek help or counseling;
choose a group of responders from a community;
solicit one or more potential solutions from the responders;
review and customize the one or more solicited solutions based on the profile of the user;
provide the one or more solicited solutions to the user.
